(19) United States
(12) Patent Application Publication
(10) Pub. No.: US 2014/0067909 A1
(43) Pub. Date: Mar. 6, 2014

(54) SHARING SOCIAL NETWORK FEEDS VIA PROXY RELATIONSHIPS

(71) Applicants: Jonas Johansson, Saint-Laurent (CA); Andre Poulin, Laval (CA); Cheng Jun Li, Pierrefonds (CA)

(72) Inventors: Jonas Johansson, Saint-Laurent (CA); Andre Poulin, Laval (CA); Cheng Jun Li, Pierrefonds (CA)

(73) Assignee: TELEFONAKTIEBOLAGET L M ERICSSON (PUBL), Stockholm (SE)

(21) Appl. No.: 13/597,473

(22) Filed: Aug. 29, 2012

(51) Int. Cl. G06F 15/16

(52) U.S. Cl. 709/203

(57) ABSTRACT

Techniques and apparatus for aggregating social network service (SNS) data are disclosed. In an example method for operating a computerized SNS aggregator having a plurality of account holders, identifiers for one or more external network-accessible SNS accounts associated with each of several account holders are collected and stored. An access token for each of the associated external network-accessible SNS accounts is collected and stored. Data-sharing relationships between pairs of account holders having linked accounts within the SNS aggregator service are identified. Subsequently, one or more account holders having a data-sharing relationship with a first account holder are identified. One or more external network-accessible SNS accounts for each of the other account holders are accessed, using the corresponding stored access tokens. Finally, a data feed for the first account holder is assembled, using data items retrieved from the external network-accessible SNS accounts for the other account holders.

### TECHNICAL FIELD

The present invention relates generally to computer networks and more particularly relates to techniques for aggregating data maintained across multiple social network services.

### BACKGROUND

Generally speaking, a computerized social networking service (SNS) is an online (i.e., accessible via a computer network) platform designed to facilitate the sharing of data among users according to a variety of relationships among those users. The shared data may include text, image, and/or video data created and/or uploaded by the users, for example. The sharing of data associated with a given user is generally managed according to a profile corresponding to that user. The profile may define, for example, a list of other users of the service that have a particular relationship, e.g., “friends” or “subscribers,” with the user. In some cases, a user's profile, which may generally be managed by the user, defines which types of information may be shared with other users, according to those other users' relationships with the user. Thus, for example, a given user's profile might specify that all or a subset of data uploaded to the SNS by the user may be viewed by individuals that are included on the user's list of “friends,” while only a few select items (e.g., a profile name and image) may be shared with the “public,” i.e., with individuals that have no defined relationship with the user.

Facebook, Twitter, and Google+ are three well-known social network services that are designed for general use. Other social network services, such as LinkedIn, are targeted more specifically to professional users seeking to establish and maintain professional connections, while still others, such as the Jive platform, are designed for enterprise use.

Because many SNS users use multiple services, several vendors have produced social network service aggregation platforms, referred to herein as SNS aggregators. For a given user, an SNS aggregator can access multiple SNS accounts for the user, on multiple SNS platforms, and collect the data visible to the user through those platforms. The SNS aggregator then consolidates the retrieved data and presents it to the user. One example of an SNS aggregator is the Alternion platform.

### SUMMARY

The information presented to the user of a typical SNS aggregator is limited by the relationships defined by the user on each of the external SNS platforms. This is because the SNS aggregator is, in effect, accessing each of the external SNS platforms on behalf of the user and can only retrieve the data that is accessible to that user on the external SNS platform. Thus, for example, if User A and User B are “friends” on the Facebook platform, an SNS aggregator acting on behalf of User A will retrieve data items that appear in User A's “feed” on Facebook, which will include items posted on Facebook by User B and shared by User B with User B's “friends.” However, if User A and User B are both users of a second SNS but have not established a relationship on that service, User A's feed on that SNS will not include data items posted by or otherwise associated with User B. As a result, the aggregated feed produced for User A by the SNS aggregator will include items posted by User B on Facebook, but will not include items posted by or associated with User B on the second SNS.

Several embodiments of the present invention address this limitation of current SNS aggregators. As a result, according to some embodiments of the SNS aggregator solutions and platforms described herein, if User A and User B have an established relationship within the SNS aggregator then the SNS aggregator can assemble a feed for User A that includes at least publicly viewable information from User B's accounts on each of the external SNS accounts that User B has identified to the SNS aggregator, even for accounts on external SNS platforms where Users A and B do not have a relationship. In some embodiments, the feed for User A assembled by the SNS aggregator may also include items posted by or otherwise associated with User B on external SNS platforms where Users A and B lack a relationship, including data items that User A could not access by logging into the external SNS platforms directly. This capability may depend, in some embodiments, on privacy settings and/or permissions established by User B on the SNS aggregator platform.

Example embodiments of the present invention include methods of operating a computerized social network service (SNS) aggregator having a plurality of account holders. In one such embodiment, identifiers for one or more external network-accessible SNS accounts associated with each of several account holders are collected and stored. An access token corresponding to each of the associated external network-accessible SNS accounts is also collected and stored. Data-sharing relationships between pairs of account holders having linked accounts within the SNS aggregator service are identified. Then, for a first account holder, one or more other account holders having a data-sharing relationship with the first account holder are identified. One or more external network-accessible SNS accounts for each of the other account holders are accessed, using the corresponding stored access tokens for the other account holder. Finally, a data feed for the first account holder is assembled, using data items retrieved from the external network-accessible SNS accounts for the other account holders.

In some embodiments, linked accounts are established in the SNS aggregator by storing, for each account holder, internal connection relationships entered by the account holder into an SNS aggregator interface. In some of these and in some other embodiments, the stored access token for each of one or more of the external network-accessible SNS accounts comprises is an Open Authentication Key corresponding to the external network-accessible SNS; this Open Authentication Key is received from the external network-accessible SNS in some embodiments.

Any of the methods summarized above may further comprise, in some embodiments, the retrieval of one or more publicly accessible data items from an external network-accessible SNS account associated with an additional other account, using a stored identifier for the external network-accessible SNS account rather than a stored access token. The feed assembled for the first account holder in these embodiments further includes the retrieved publicly accessible data items.

In some embodiments, the SNS aggregator service uses information retrieved from the external network-accessible SNS accounts to identify connection relationships between account holders for the SNS aggregator service. Thus, several example methods include an identification of the first account holder's external connection relationships with one or more third parties, from one or more of the external network-accessible SNS accounts for the first account holder. Corresponding accounts on the SNS aggregator for the third parties are identified, and new data-sharing relationships within the SNS aggregator between the first account holder and the third parties are established and stored. Subsequently, one or more external network-accessible SNS accounts are accessed, using the corresponding access tokens for the respective third parties, and the feed for the first account holder is assembled using additional data items retrieved from the external network-accessible SNS accounts for the third parties. In some cases, the first account holder's external connection relationships within the one or more external social network services are scanned, updated external connection relationships with additional third parties in the SNS aggregator are stored, and updated data-sharing relationships between the first user and the additional third parties are established within the SNS aggregator. In some cases, this scanning is performed pursuant to a schedule, or in response to a data trigger, or in response to an explicit request from an account holder.

In several embodiments, the identification of data-sharing relationships in the SNS aggregator includes the collecting, from account holders, of customized personal sharing filters. In these embodiments, the data items retrieved from at least one external network-accessible SNS are filtered, pursuant to the customized personal sharing filters, prior to assembling the feed for the first account holder. This filtering may be based on system-wide criteria, group-based criteria, or individual-based criteria, to select data items retrieved from an external network-accessible SNS.

Other embodiments of the present invention include a computerized SNS aggregator providing data links among a plurality of account holders within the aggregator and operating according to one or more of the methods summarized above. Some of these embodiments include a storage system as well as one or more processing elements configured to: collect and store, in the storage system, identifiers for one or more external network-accessible SNS accounts associated with each account holder; collect and store, in the storage system, one or more access tokens corresponding to each of the associated external network-accessible SNS accounts; and identify and store, in the storage system, data-sharing relationships between pairs of the account holders having linked accounts in the SNS aggregator. The processing elements in these embodiments are further configured to, for a first account holder: access one or more external network-accessible SNS accounts for at least one other account holder, using the corresponding stored external network-accessible SNS access tokens for the other account holder; assemble a feed for the first account holder using data items retrieved from the external network-accessible SNS accounts for the other account holder; and present the feed to the first account holder.

Details of the above-summarized embodiments and other embodiments of the present invention are given below. Those skilled in the art will recognize additional features and advantages of the invention upon reading the following detailed description, and upon viewing the accompanying drawings.

### BRIEF DESCRIPTION OF THE DRAWINGS

FIG. 1 illustrates an example relationship between a Social Network Service (SNS) aggregator, a plurality of account holders, and a plurality of external SNS platforms.

FIG. 2 illustrates another example relationship between a Social Network Service (SNS) aggregator, a plurality of account holders, and a plurality of external SNS platforms, according to some embodiments of the present invention.

FIG. 3 is a flow diagram illustrating a series of example transactions according to some embodiments of the invention.

FIG. 4 is a process flow diagram illustrating an example method according to some embodiments of the invention.

FIG. 5 is a block diagram illustrating a computer network that includes an SNS aggregator according to some embodiments of the present invention.

FIG. 6 is another block diagram illustrating an SNS aggregator platform configured according to some embodiments of the invention.

### DETAILED DESCRIPTION

In the context of a social network service (SNS), the term “relationship,” as used herein, refers to a data-sharing relationship established in a given SNS platform. Some platforms may support several types of data-sharing relationships, where the types and/or quantities of information shared among linked users depends on the type of data-sharing relationships. To simply the following discussion, distinctions between these various types are generally ignored, but it will be appreciated that these distinctions can affect the content of a feed presented to any given user.

In the following discussion, the term “Account Holder” is used frequently to refer to users of an SNS. The use of this term recognizes that an SNS typically maintains a profile, or “account,” for its users, the profile including such things as login credentials (e.g., identifier and password, viewing and notification preferences, privacy settings, and the like. However, the term “User” may also be used in the following detailed description and should be understood to be interchangeable with the term “Account Holder.”

Information presented to the user of a conventional social network service (SNS) aggregator is limited by the relationships defined by the user on each of the external SNS platforms. This is because the conventional SNS aggregator is, in effect, accessing each of the external SNS platforms on behalf of the aggregator's user, and can only retrieve the data that is accessible to that user on the external SNS platform. The conventional SNS aggregator is thus relying on its users to establish relationships on each external SNS so that the SNS aggregator can later share this data across its own users.

For example, assume that User A belongs to SNS 1, where User B also holds an account. Further assume that User A and User B also join SNS 2. In order for A and B to “see” each other within a given SNS, i.e., to receive information originated by the other or otherwise linked to the other, they need to establish a relationship on that SNS.

Next, assume that User A is using a conventional SNS aggregator to consolidate User A's feeds from SNS 1 and SNS 2. In order for the conventional SNS aggregator to present User A to receive data associated with User B from both SNS 1 and SNS 2, User A and User B must have a sharing relationship on both networks.

Thus, for example, if User A and User B are “friends” on the Facebook platform, a conventional SNS aggregator acting on behalf of User A will retrieve data items that appear in User A's “feed” on Facebook, which will include items posted on Facebook by User B and shared by User B with User B's “friends.” However, if User A and User B are both users of a second SNS but have not established a relationship on that service, User A's feed on the second SNS will not include data items posted by or otherwise associated with User B. As a result, the aggregated feed produced for User A by the SNS aggregator will include items posted by User B on Facebook, but will not include items posted by or associated with User B on the second SNS.

According to several embodiments of the present invention, however, an SNS aggregator uses relationships established within the SNS aggregator community itself to determine which information to retrieve from external SNS platforms and to present to users of the SNS aggregator. Thus, for example, User A and User B, both account holders of the SNS aggregator service, each identify their external SNS accounts to the SNS aggregator. If User A and User B then establish a data-sharing relationship in the SNS aggregator service, e.g., if User A and User B mutually confirm that they are friends, or contacts, the SNS aggregator accesses the external SNS platforms identified by User B and uses at least the public data items associated with User B's external accounts to create a feed for User A. Likewise, the SNS aggregator accesses the external SNS platforms identified by User A and uses at least the public data items associated with User A's external accounts to create a feed for User B. Importantly, this can be done without regard to whether User A and User B have a data-sharing relationship on any or all of the external SNS platforms, and without regard to whether User A and User B both have accounts on each external SNS.

Thus, by using an established relationship within the local SNS aggregator community the system can use public data from external SNS platforms to enrich aggregated feeds for the SNS aggregator's users. For example, if User A has established a data-sharing relationship with Users B, C, and D within the SNS aggregator, the SNS aggregator can retrieve data items from the public Twitter feeds for Users B, C, and D, and include those data items in an aggregated feed for User A, even if User A does not have an established relationship with one or more of Users A, B, and C within the Twitter service.

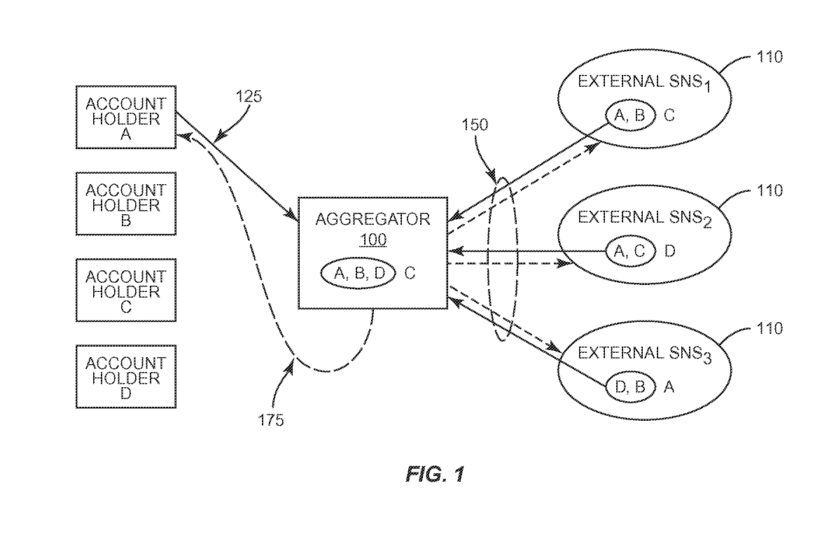

FIG. 1 illustrates an example of this approach according to some embodiments of the present invention. SNS aggregator 100 provides aggregation services for several account holders, including Account Holders A, B, C, and D. SNS aggregator 100 is configured to access multiple external SNS platforms 110, including SNS platforms SNS1, SNS2, and SNS3. In addition to providing conventional aggregation services, i.e., simply consolidating for each user the feeds that the user would see if he logged into each of the external platforms 110 separately, SNS aggregator 110 also provides its own social network functionality to its users. Thus, Account Holders A, B, C, and D can establish relationships within SNS aggregator 100, independently of their relationships in the external SNS platforms 110. As shown in FIG. 1, for example, Account Holder A has a relationship with Account Holders B and D in the SNS aggregator 100, but is not connected to Account Holder C. As will be seen below, these relationships within the SNS aggregator 100 determine what information is collected and presented to each user of the SNS aggregator 100.

For instance, while using SNS aggregator 100, Account Holder A requests an aggregated feed, as shown at 125. Note that Account Holder A has earlier established an account on SNS aggregator 100, identified one or more external SNS accounts that he uses, and established a relationship with Account Holders B and D. Also note that Account Holder A's “request” for an aggregated feed need not be explicit—it may be triggered, for example, by simply logging into the SNS aggregator 110 or activating an SNS aggregator client that connects to the SNS aggregator platform.

In response to the request, whether explicit or implicit, SNS aggregator 100 presents an aggregated feed to Account Holder A, as shown at 175. This presentation may utilize any of a number of conventional communication and/or formatting protocols. For instance, the presentation may comprise returning an HyperText Markup Language (HTML)—formatted browser page to a browser client on Account Holder A's personal computer, smartphone, or similar device, using conventional TCP/IP communications. Alternatively, the presentation may be based on customized formatting and/or customized communications protocols between the SNS aggregator 100 and a proprietary client program on the account holder's device.

The aggregated feed presented to Account Holder A may be assembled by SNS aggregator 100 directly in response to Account Holder A's request, or SNS aggregator 100 may regularly maintain an updated, assembled feed, ready to present to Account Holder A in response to A's request.

In either case, the information included in the assembled feed presented to Account Holder A is based, at least in part, on Account Holder A's relationships within the SNS aggregator 100. Based on the external SNS identification information provided by Account Holder A, SNS aggregator 100 can access each of the external SNS platforms 110 that Account Holder A uses, to retrieve Account Holder A's feeds from each of those platforms, as shown at 150. This access will generally involve the use of credentials supplied by Account Holder A or supplied by the external SNS platform 100 with Account Holder A's authorization. For instance, several SNS platforms use the Open Authentication architecture and protocols, known as “OATH,” to control third-party access to users' accounts. Information about OATH can be obtained from www.openauthentication.org. Note that for the purposes of this disclosure, the credentials supplied to the SNS aggregator 100 or accessing account holders' accounts on external SNS platforms are referred to as “access tokens.” These access tokens may include credentials that are distinct from the account holders' user IDs and passwords and granted through an authentication process like those used in the OATH architecture. However, the term as used herein may also refer to other types of credentials that provide access to all or part of an account holder's information, including the account holder's user ID and password.

Because the approach described above uses Account Holder A's access tokens to access external SNS platforms 110, it will be appreciated that the content of the feeds retrieved from those platforms and used to assemble an aggregated feed for Account Holder will depend on Account Holder A's relationships on those platforms. For example, referring once again to FIG. 1, it can be seen that Account Holder A and Account Holder B have a data-sharing relationship on external SNS1, but not on external SNS2 or external SNS3. In fact, Account Holder B is not present on external SNS2 at all. In this example, the data retrieved from the external SNS platforms 110 to assemble Account Holder A's feed will include data that Account Holder B shares with Account Holder A on external SNS1. The data used to assemble Account Holder A's feed may also include data that Account Holder C shares with Account Holder A on external SNS2, depending on the configuration of SNS aggregator 100 and/or permissions or filter settings established by Account Holders A and C on the SNS aggregator 100. In some embodiments, for example, SNS aggregator 100 may be configured to ignore or discard data shared between Account Holders A and C on external SNS2 because Account Holders A and C do not have a data-sharing relationship on SNS aggregator 100. In others, SNS aggregator 100 may include in Account Holder's aggregated feed data shared by Account Holder C with Account Holder A on external SNS2, despite the lack of a local data-sharing relationship between Account Holders A and C on the SNS aggregator 100. Note that because SNS aggregator 100 is an SNS in its own right, the aggregated feed presented to Account Holder A may also include data retrieved from the internal accounts of Account Holders B and D.

In some embodiments, SNS aggregator 100 is configured to further enrich Account Holder A's aggregated feed, based on the data-sharing relationships established within the SNS aggregator 100 community. For instance, it can be seen in FIG. 1 that Account Holders A and D have a data-sharing relationship within the SNS aggregator 100, but do not have a relationship on external SNS2. Despite the lack of an explicit relationship on external SNS2, SNS aggregator 100 may be configured to retrieve Account Holder D's “public” information from external SNS2 and to use that information in assembling Account Holder A's aggregated feed. The term public information as used here refers to data that is associated with Account Holder D's account (for example) on the external SNS platform and that is accessible to users of the external SNS platform that do not have a particularized data-sharing relationship with Account Holder Don that platform. In these embodiments, then, Account Holder A's aggregated feed is supplemented with data associated with Account Holder D that would not normally be found in Account Holder A's feed on the external SNS platform. It should be noted that this approach is not limited to public information from external SNS platforms on which Account Holder A has an account. In some embodiments, for example, SNS aggregator 100 may be configured to access external SNS platforms where Account Holder D has an account but where Account Holder A does not, retrieve public information associated with Account Holder D, and use that public information to supplement the aggregated feed presented to Account Holder A.

Some embodiments may go even further and use the relationships within the local SNS aggregator to infer data-sharing permissions for external SNS platforms, so that a given user's aggregated feed can be enriched with data items from external SNS platforms that the user would not be able to see if he accessed the external SNS platforms himself. For example, if User A and User B have a data-sharing relationship on the SNS aggregator, an SNS aggregator configured according to these embodiments is able to retrieve data items posted by User B in Facebook and use those data items in the aggregated feed provided to User A, even if Users A and B do not have a relationship on Facebook, and even if User A has no account on Facebook at all.

It will be appreciated that this approach necessarily requires SNS aggregator 100 to access, for assembling Account Holder A's aggregated feed, data items that Account Holder A could not access himself. This is done by using access tokens associated with the other Account Holders. For example, in some embodiments of SNS aggregator 100, by consenting to a data-sharing with Account Holder A on SNS aggregator 100, Account Holders B and D implicitly grant SNS aggregator 100 permission to access data associated with their accounts on external SNS platforms 110, without regard to whether they have data-sharing relationships with Account Holder A on those platforms. Then, SNS aggregator 100 uses access tokens for Account Holder B's accounts and Account Holder D's accounts to retrieve data for assembling Account Holder A's feed.

In some embodiments, the data retrieved from external SNS platforms 110 will depend on system-driven filters, privacy settings, and/or permissions established by each user on the SNS aggregator platform. For instance, the system can also implement filters for personal sharing on the SNS aggregation service, so that sharing of one user's data from a particular external SNS can be blocked, in a permanent or dynamic fashion, from even other users that have an extensive data-sharing relationship with the first user in the external SNS. In some cases, permissions granted to the SNS aggregator may be set by a user on an SNS-by-SNS basis. Thus, for example, in some of these embodiments User B may permit the SNS aggregator to share User B's private information from Facebook with users of the SNS aggregator service that have a particular data-sharing relationship with User B on the SNS aggregator service, while not permitting the SNS aggregator to share User B's “tweets” from Twitter with anyone that does not have an established relationship with User B on the Twitter platform.

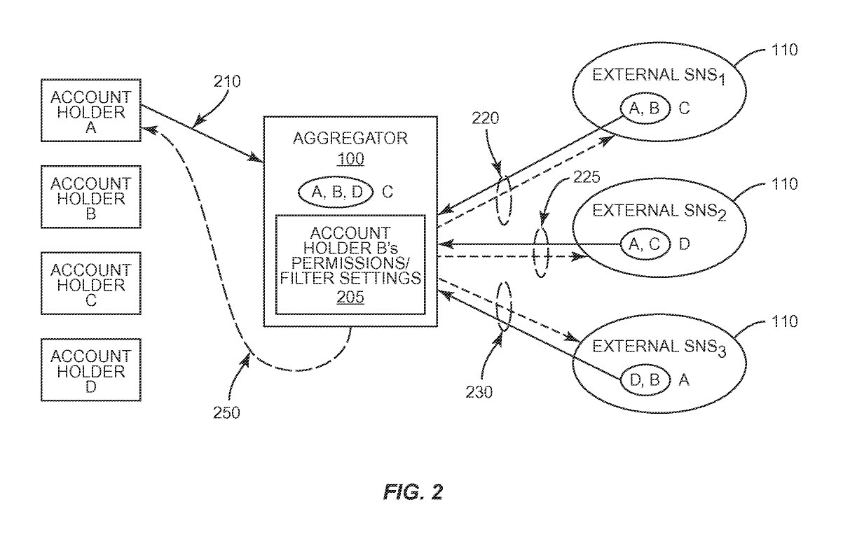

An example of this approach is illustrated in FIG. 2. As was the case in FIG. 1, Account Holder A has established data-sharing relationships on SNS aggregator 100 with Account Holders B and D. In addition, Account Holder B has established certain permissions and/or filter settings 205 within SNS aggregator 100. Some of these permissions may be set automatically, in response to an account setup, for example, while others may be individually set by Account Holder B, using an interface provided by the SNS aggregator 100. These permissions and filter settings may be system-based, i.e., individualized for external SNS platforms, individual-based, i.e., restricting or granting certain sharing permissions for particular user accounts within the SNS aggregator 100, or group-based, i.e., restricting or granting certain sharing permissions for user-defined and/or aggregator-defined groups of user accounts. Other categories of permissions and/or filter settings are also possible, as are combinations of these. For example, Account Holder B's permissions/filter settings 205 may specify that Account Holder B's private information from external SNS1 may be shared with anyone having a data-sharing relationship with Account Holder B on SNS aggregator 100, while also specifying that Account Holder B's private information from external SNS2 may be shared only with persons that are identified by Account Holder B of a group of relationships designated “Family Members.”

Referring back to FIG. 2, Account Holder A requests an aggregated feed, as shown at 210. As was the case in the example illustrated in FIG. 1, this request may be explicit, or automatically triggered by logging in to SNS aggregator 100, or triggered by some other event. In this case, however, the contents of the assembled feed returned to Account Holder A, as seen at 250, are affected by Account Holder B's permissions/filter settings 205. (Of course, they may be affected by permissions and/or filter settings for Account Holder D, as well.) Further, in this example, SNS aggregator 100 is configured to use the relationships established on the SNS aggregator 100 to retrieve, from one or more of the external SNS platforms 110, data that Account Holder A would not see if he logged onto the external SNS platforms 110 directly.

More particularly, SNS aggregator 100 accesses external SNS1, as shown at 220, using access tokens corresponding to each of Account Holders A and B, because A and B have a data-sharing relationship on the SNS aggregator 100. Data associated with Account Holder B's account on external SNS1 is filtered, before including it in Account Holder A's aggregated feed, using Account Holder B's permissions/filter settings 205. Similarly, SNS aggregator 100 accesses external SNS3, as shown at 230, using access tokens corresponding to each of Account Holders A, B, and D, and again filters information associated with Account Holder B's account based on Account Holder B's permissions/filter settings 205. Note that in this case Account Holder A does not have a data-sharing relationship with Account Holders B and D on external SNS3. Nevertheless, if Account Holder B's permissions/filter settings 205 allow it, SNS aggregator 100 may use data associated with Account Holder B's account on external SNS3 in assembling the aggregated feed for Account Holder A, even if that data would not be visible to Account Holder A upon logging in to external SNS3 directly.

Finally, SNS aggregator 100 accesses external SNS2, as shown at 225, using access tokens for Account Holders A and D. (Because Account Holders A and C are not linked on SNS aggregator 100, permission to access Account Holder C's external SNS accounts to build Account Holder A's aggregated feed is not granted to SNS aggregator 100, in this example.) Data retrieved from external SNS2 includes data shared by Account Holder C with Account Holder A on external SNS2, because of the data-sharing relationship on the external SNS platform. Depending on the configuration of SNS aggregator 100 and/or permissions/filter settings for Account Holder D, data retrieved for Account Holder A's aggregated feed may include only Account Holder D's public information, in some cases. In others, Account Holder D's permissions/filter settings on SNS aggregator 100 may permit the retrieval of Account Holder D's private information from external SNS2, for use in Account Holder A's aggregated feed, despite the lack of a data-sharing relationship between Account Holders A and D on external SNS2.

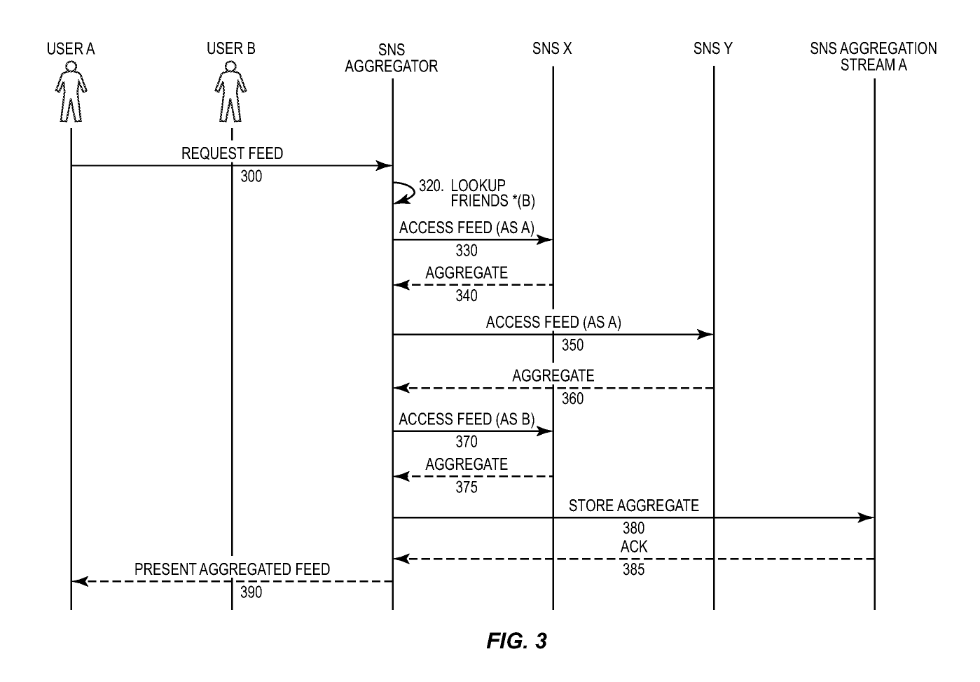

FIG. 3 is a flow diagram illustrating a series of similar transactions according to some embodiments of the invention. In the scenario illustrated in this figure, Users A and B have an established data-sharing relationship in the SNS aggregator. As seen at 310, User A requests an aggregated feed from the SNS aggregator. The SNS aggregator then identifies other account holders having a data-sharing relationship with User A, as shown at 320, in this case determining that Users A and B are “friends” within the SNS aggregator. Next, as shown at steps 330, 340, 350, and 360, the SNS aggregator accesses SNS X and SNS Y, using access tokens corresponding to User A's accounts on those external SNS platforms, and retrieves data that would be visible to User A on those platforms for assembling User A's aggregated feed. (This scenario assumes that User A has previously identified these SNS platforms to the SNS aggregator.) Because Users A and B have a data-sharing relationship on the SNS aggregator, the SNS aggregator also accesses SNS X using an access token corresponding to User B's external SNS account, and retrieves data corresponding to User B's account, for use in assembling User A's aggregated feed. This is shown at 370 and 375. (This scenario assumes that User B has previously linked external SNS X to her SNS aggregator account.) The retrieved items are filtered (not shown) to reflect permissions and/or filter settings applicable to Users A and B, and may be further processed to remove duplicate data items. As shown at 380 and 385, the aggregated feed for User A is stored, and the fully aggregated feed is finally presented to User A, as shown at 390.

As shown in the examples illustrated in FIGS. 2 and 3, even if a pair of linked account holders in the SNS aggregator system do not share relationships in all external SNS platforms, an SNS aggregator configured according to several embodiments of the invention can use systematic, individual-based, and/or group-based filters maintained within the SNS aggregator to share data between those account holders, based on their established relationship inside the SNS aggregation system.

As users join the aggregation service they “attach” their external SNS accounts to their aggregation service accounts. Accordingly, the aggregation system will be able to gather a Unique ID for each external SNS and collect and store an access token for each of the external SNS accounts associated with each user. As discussed above, using an Application Programming Interface (API) specific to each external SNS, it can collect information to assemble into aggregated feeds for its users.

In some embodiments, the SNS aggregator is further configured to use its access to the external SNS accounts for each user to collect information defining that user's data-sharing relationships in the external SNS accounts, e.g., to collect a list of each user's “Friends” in Facebook. The SNS aggregator can then assemble an internal database that specifies external SNS relationships between users of the SNS aggregator. This information may be used to supplement and/or update account holders' relationships within the SNS aggregator, which in turn will affect which information is provided to each account holder in his or her aggregated feed.

In some cases, this can be done automatically, i.e., without any user interaction, except, perhaps for an explicit opt-in by each user. In other embodiments, data gleaned in this fashion may be used to suggest new aggregator relationships to the aggregator's users, with the actual relationship established only upon mutual consent of the users. With either approach, the system may re-scan external SNS platforms for new or modified relationships, from time to time, based on a schedule, data triggers, or user actions. With a systemic filter based on user-to-user privacy, or driven by group-based privacy policies, the aggregation service can detect when external relationships are formed and as such can decide what data from which external SNS can be shared or not. By using a user-centric privacy filter in addition to the relationships within the aggregator, the user can set up scopes, or permissions, within the external relationships, which the aggregator will obey when using the exchanged tokens. These scopes can be finite so that the privacy of the external data is respected as if they were formed externally.

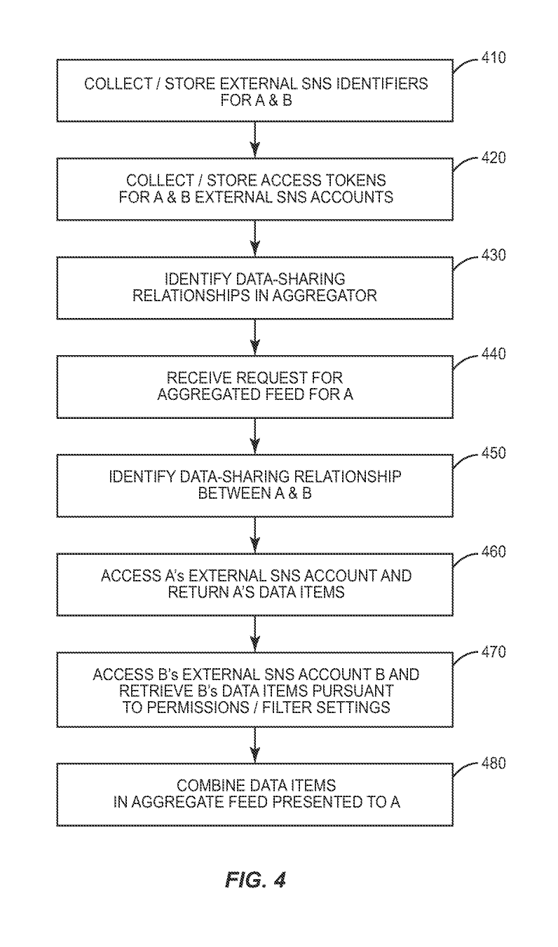

FIG. 4 is a process flow diagram illustrating an example method for operating a computerized social network service (SNS) aggregator, which combines several of the techniques discussed above. It should be noted, however, that these techniques may be combined in different ways, in some embodiments of the present invention.

As shown at block 410, the illustrated method begins with collecting and storing identifiers for one or more external network-accessible SNS accounts associated with each of several account holders, in this case Users A and B. The method continues, as shown at block 420, with the collecting and storing of an access token corresponding to each of the associated external network-accessible SNS accounts for each of the account holders. In some embodiments, collecting and storing the access token for each of one or more of the external network-accessible SNS accounts involves collecting and storing an Open Authentication Key corresponding to the external network-accessible SNS. This may be done, in some instances, by receiving the Open Authentication Key from the external network-accessible SNS, pursuant to an authorization by the respective account holder.

As shown at block 430, the SNS aggregator identifies and tracks data-sharing relationships among the aggregator's account holders, i.e., relationships established within the SNS aggregator system. These may be relationships that are initiated and/or mutually confirmed, within the SNS aggregator system, by its users, but may also include relationships that are identified by the SNS aggregator when accessing account holders' accounts in external SNS platforms, and imported into the SNS aggregator. Accordingly, in some embodiments of the present invention the SNS aggregator establishes linked user accounts by storing, for each account holder, internal connection relationships entered by the account holder into an interface provided to system users by the SNS aggregator.

As shown at block 440, the SNS aggregator receives a request for an aggregated feed for User A. As noted above, this may be triggered, for example, by User A's logging into the SNS aggregator system. The SNS aggregator then identifies one or more other account holders having a data-sharing relationship with User A, as shown at block 450, in this case identifying the data-sharing relationship with User B.

Next, as shown at block 460, the SNS aggregator accesses User A's external SNS account(s), and returns data items from User A's feeds on those external SNS platforms. The SNS aggregator also accesses one or more external network-accessible SNS accounts for each of the account holders having a data-sharing relationship with User A in the SNS aggregator system, using the corresponding stored access tokens for the other account holder. This is shown at block 470 for User B's external SNS account(s). In some cases, the SNS aggregator may also retrieve one or more publicly accessible data items from an external network-accessible SNS account associated with another account holder, based on a relationship between User A and the other account holder. In this case, the SNS aggregator may use the stored identifier for the external network-accessible SNS account.

Finally, as shown at block 480, the SNS aggregator assembles a data feed for User A using the retrieved data items, including data items retrieved from the external network-accessible SNS accounts for User B, and presents the aggregated feed to User A.

Although not illustrated in FIG. 4, it should be appreciated that the techniques illustrated in FIG. 4 may be combined with techniques for discovering and/or suggesting data-sharing relationships between users of the SNS aggregator. Thus, in some cases, the SNS aggregator identifies, from one or more of the external network-accessible SNS accounts for User A, User A's external connection relationships with a third party and identifies a respective account on the SNS aggregator for the third party. The SNS aggregator may then establish and store a new data-sharing relationship within the SNS aggregator between User A and the third party, in some cases automatically and in other cases only upon explicit consent from User A and/or the third party. Subsequently, the SNS aggregator will be able to access one or more external network-accessible SNS accounts for the third party when assembling a data feed for User A, using the corresponding access tokens for the third party.

Also not shown in FIG. 4 are filtering operations. However, it will be appreciated that the filtering techniques discussed earlier may be applied to the process illustrated in FIG. 4. Thus, several methods of the sort illustrated in FIG. 4 may further include filtering the data items available from at least one external network-accessible SNS pursuant to customized personal sharing filters that are collected from account holders as part of the identification of data-sharing relationships. This filtering may be accomplished, for example, using a filter comprising system-wide criteria, group-based criteria, or individual-based criteria. These filtering operations may further include de-duplication processing, in which duplicate items collected from multiple sources or multiple feeds from the same source are deleted or combined when preparing the aggregated feed for the user.

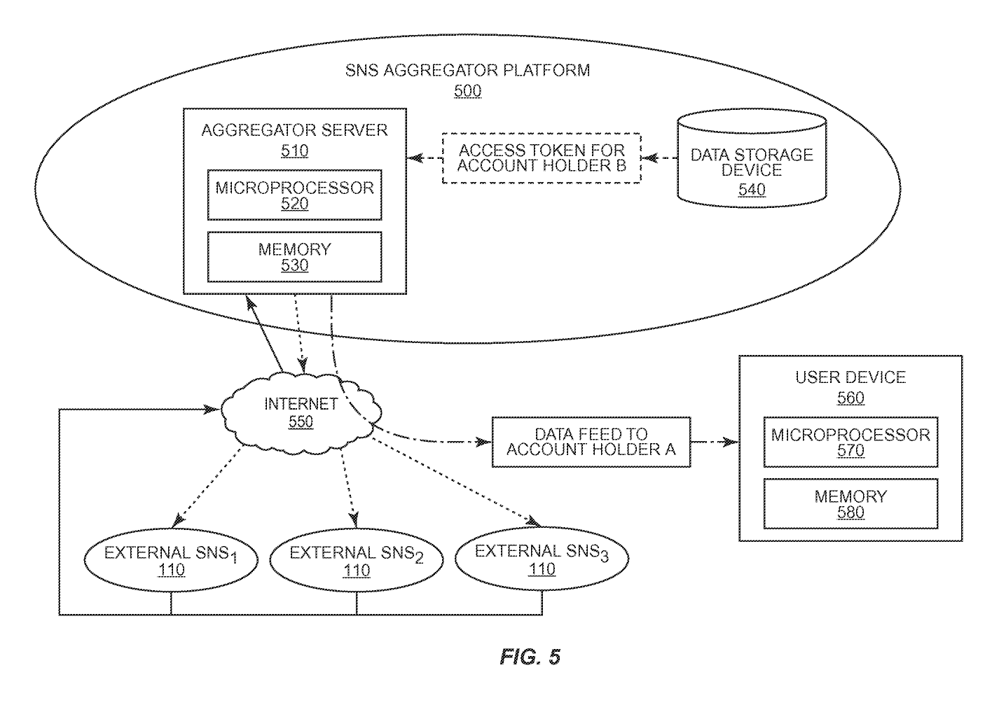

FIG. 5 illustrates an example SNS aggregator platform 500, coupled to several external SNS platforms 110 and a user device 560 through the Internet 550. As shown here, an SNS aggregator system configured according to any of the techniques described herein will generally be accessible through the Internet, although an SNS aggregator system could operate in a private data communications instead.

In the pictured system, SNS aggregator platform 500 includes an aggregator server 510, which in turn includes a processing circuit made up of at least one microprocessor 520 and associated memory 530. Memory 530 stores program instructions for use by microprocessor 520, thus configuring aggregator server 510 to carry out one or more of the techniques described above. Aggregator platform 500 further includes a data storage device 540, which is used, for example, to store access tokens, user account profiles, data-sharing relationship information, etc. It will be appreciated that the functionalities represented by aggregator 510 and data storage device 540 may be distributed across several physical devices, whether in the same or different physical locations.

User device 560, which may be, for example, a personal computer, a smartphone, a tablet computer, or the like, has a similar structure to aggregator server 510, including a processing circuit made up of at least one microprocessor 570 and associated memory 580. Memory 580 stores program instructions and program data for use by microprocessor 570, configuring user device 560 to access an SNS aggregator service configured according to the presently disclosed techniques.

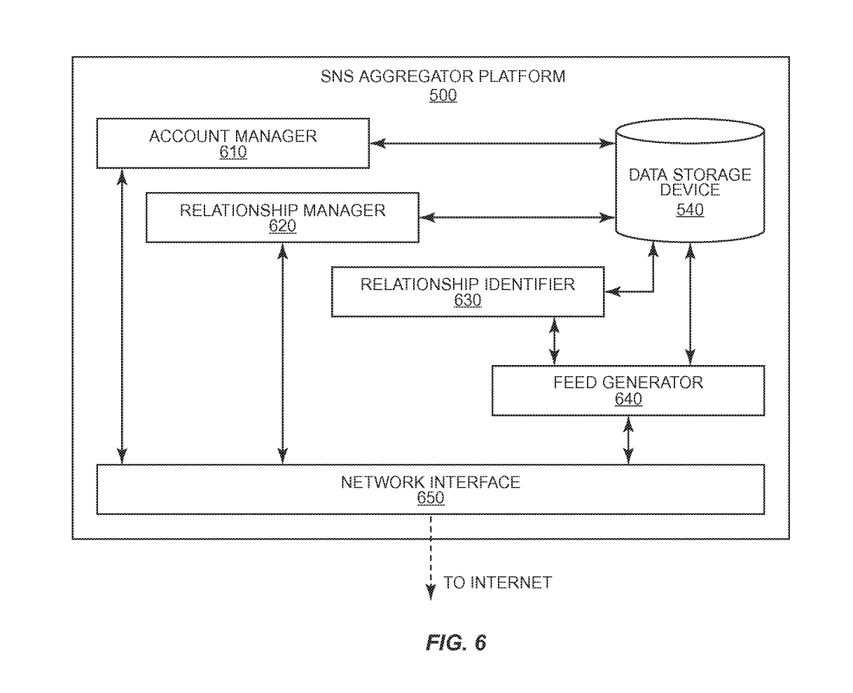

FIG. 6 provides another view of SNS aggregator platform 500, this time illustrating several functional modules coupled to a data storage device 540 and to a network interface 650. Each of the functional modules 610, 620, 630, and 640 may be implemented, for example, as a processing circuit comprising one or more microprocessors coupled to program memory storing appropriate program instructions for carrying out the techniques described earlier. It should be appreciated that one or more of the functional modules illustrated in FIG. 6 may be implemented using two or more microprocessors and associated memory device(s) and/or that two or more of the functional modules may be implemented on the same microprocessor and using the same associated memory device. Network interface 650, which connects the SNS aggregator platform 500 to the Internet, for example, may comprise network interface hardware as well as one or more appropriately configured microprocessors configured to execute appropriate physical layer and network interface protocols, such as Ethernet and TCP/IP protocols.

The functional modules illustrated in FIG. 6 include an account manager 610, which is configured to collect and store one or more external network-accessible SNS access tokens for each of a plurality of account holders, as well as a relationship manager 620, which is configured to identify and store data-sharing relationships between pairs of the account holders. SNS aggregator platform 500 further includes a relationship identifier, which is configured to identify one or more other account holders having a particular data-sharing relationship with a first account holder, based on the stored data-sharing relationships, and a feed generator 640. The feed generator 640 is configured to, among other things: access one or more of the external network-accessible SNS accounts for the first account holder, using the corresponding stored external network-accessible SNS access tokens for the other account holders; assemble a feed for the first account holder using data items retrieved from external network-accessible SNS accounts for the other account holders; and present the feed to the first account holder. Feed generator 640 carries out these operations using information retrieved from data storage device 540, and communicates with external SNS platforms and account holder clients using network interface 650. It will be appreciated that any of the various techniques described above for operating a computerized social network service aggregator service may be applied to SNS aggregator platform 500.

In the preceding discussion and in the claims that follow, terms such as “first”, “second”, and the like, are used to distinguish various elements, regions, sections, etc., from one another and are not intended to imply a particular order or priority, unless the context clearly indicates otherwise. Like terms refer to like elements throughout the description. Likewise, as used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise. When a process is illustrated or claimed herein, it should be understood that the steps or operations of that process may be performed in any order unless the context clearly requires otherwise. Finally, it is to be understood that the features of the various embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of operating a computerized social network service (SNS) aggregator having a plurality of account holders, the method comprising:
for each account holder, collecting and storing identifiers for one or more external network-accessible SNS accounts associated with the account holder;
for each account holder, collecting and storing an access token corresponding to each of the associated external network-accessible SNS accounts;
identifying data-sharing relationships between pairs of account holders having linked accounts within the SNS aggregator service;
for a first account holder, identifying one or more other account holders having a data-sharing relationship with the first account holder;
accessing one or more external network-accessible SNS accounts for each of the other account holders, using the corresponding stored access tokens for the other account holder; and
assembling a data feed for the first account holder using data items retrieved from the external network-accessible SNS accounts for the other account holders.

2. The method of claim 1, further comprising establishing linked accounts by storing, for each account holder, internal connection relationships entered by the account holder into an SNS aggregator interface.

3. The method of claim 1, wherein collecting and storing the access token for each of one or more of the external network-accessible SNS accounts comprises collecting and storing an Open Authentication Key corresponding to the external network-accessible SNS.

4. The method of claim 3, wherein collecting and storing an Open Authentication Key comprises receiving the Open Authentication Key from the external network-accessible SNS.

5. The method of claim 1, further comprising, for each of one or more additional other account holders, retrieving one or more publicly accessible data items from an external network-accessible SNS account associated with the additional other account holder, using the stored identifier for the external network-accessible SNS account, wherein assembling the feed for the first account holder further comprises using the retrieved publicly accessible data items.

6. The method of claim 1, further comprising:
identifying, from one or more of the external network-accessible SNS accounts, the first account holder's external connection relationships with a third party;
identifying a respective account on the SNS aggregator for the third party;
establishing and storing a new data-sharing relationship within the SNS aggregator between the first account holder and the third party; and
accessing one or more external network-accessible SNS accounts for the third party, using the corresponding access tokens for the third party;
wherein assembling the feed for the first account holder further comprises using additional data items retrieved from the external network-accessible SNS accounts for the third party.

7. The method of claim 6, wherein identifying the first account holder's external connection relationships further comprises:
scanning the first account holder's external connection relationships within the one or more external social network services;
storing updated external connection relationships with additional third parties in the SNS aggregator; and
establishing and storing updated data-sharing relationships within the SNS aggregator for the first account holder and the additional third parties.

8. The method of claim 7, wherein said scanning occurs pursuant to a schedule, a data trigger, or a request from the identified account holder.

9. The method of claim 1, wherein identifying data-sharing relationships comprises collecting, from account holders, customized personal sharing filters on the aggregator service.

10. The method of claim 9, further comprising filtering the data items available from at least one external network-accessible SNS pursuant to the customized personal sharing filters.

11. The method of claim 10, wherein the filtering is accomplished via a filter comprising system-wide criteria, group-based criteria, or individual-based criteria to select data items retrieved from an external network-accessible SNS.

12. A computerized SNS aggregator providing data links among a plurality of account holders within the aggregator, comprising:
a storage system; and
one or more processing elements configured to:
collect and store, in the storage system, identifiers for one or more external network-accessible SNS accounts associated with each account holder;
collect and store, in the storage system, one or more access tokens corresponding to each of the associated external network-accessible SNS accounts;
identify and store, in the storage system, data-sharing relationships between pairs of the account holders having linked accounts in the SNS aggregator;
for a first account holder, access one or more external network-accessible SNS accounts for at least one other account holder, using the corresponding stored external network-accessible SNS access tokens for the other account holder;
assemble a feed for the first account holder using data items retrieved from the external network-accessible SNS accounts for the other account holder; and
present the feed to the first account holder.

13. The aggregator of claim 12, wherein said processing elements are configured to collect and store the one or more external network-accessible SNS access tokens by collecting and storing an Open Authentication Key from an external network-accessible SNS.

14. The aggregator of claim 12, wherein said processing elements are configured to identify and store the data-sharing relationships for account holders by establishing personal sharing filters in relation to other accounts on the aggregator service.

15. The aggregator of claim 12, wherein the one or more processing elements are further configured to, for each of one or more additional other account holders, retrieve one or more publicly accessible data items from an external network-accessible SNS account associated with the additional other account holder, using the stored identifier for the external network-accessible SNS account, and to assemble the feed for the first account holder using the retrieved publicly accessible data items.

16. The aggregator of claim 12, wherein the one or more processing elements are further configured to:
identify, from one or more of the external network-accessible SNS accounts, the first account holder's external connection relationships with a third party;
identify a respective account on the SNS aggregator for the third party;
establish and store a new data-sharing relationship within the SNS aggregator between the first account holder and the third party;
access one or more external network-accessible SNS accounts for the third party, using the corresponding access tokens for the third party, and
assemble the feed for the first account holder using additional data items retrieved from the external network-accessible SNS accounts for the third party.

17. The aggregator of claim 16, wherein the one or more processing elements are further configured to:
scan the first account holder's external connection relationships within the one or more external social network services;
store updated external connection relationships with additional third parties in the SNS aggregator; and
establish and store updated data-sharing relationships within the SNS aggregator for the first account holder and the additional third parties.

18. The aggregator of claim 17, wherein said processing elements are configured to scan the first account holder's external relationships pursuant to a schedule, a data trigger, or a request from the identified account holder.

19. The aggregator of claim 17, wherein said processing elements are configured to identify data-sharing relationships by collecting from account holders customized personal sharing filters on the aggregator service.

20. The aggregator of claim 19, wherein said processing elements are further configured to filter the data items available from at least one external network-accessible SNS pursuant to the customized personal sharing filters.

21. The aggregator of claim 20, wherein said processing elements are configured to use a filter utilizing at least one of system-wide criteria, group-based criteria, or individual-based criteria to select data items retrieved from an external network-accessible SNS.

22. A computerized SNS aggregator, comprising:
an account manager configured to collect and store one or more external network-accessible SNS access tokens for each of a plurality of account holders;
a relationship manager configured to identify and store data-sharing relationships between pairs of the account holders;
a relationship identifier configured to identify one or more other account holders having a particular data-sharing relationship with a first account holder, based on the stored data-sharing relationships; and
a feed generator configured to:
access one or more of the external network-accessible SNS accounts for the first account holder, using the corresponding stored external network-accessible SNS access tokens for the other account holders;
assemble a feed for the first account holder using data items retrieved from external network-accessible SNS accounts for the other account holders; and
present the feed to the first account holder.

23. The SNS aggregator of claim 22, wherein said relationship identifier is configured to identify linked accounts by storing, for each account holder, internal connection relationships entered by the account holder within the SNS aggregator.

24. The SNS aggregator of claim 22, wherein said account storage manager is configured to collect and store an Open Authentication Key corresponding to each of one or more of the external network-accessible SNS accounts.

25. The SNS aggregator of claim 24, wherein said account storage manager is configured to receive one or more of the Open Authentication Keys from the corresponding external network-accessible SNS.
